(19) United States
(12) Patent Application Publication
(10) Pub. No.: US 2025/0291460 A1
(43) Pub. Date: Sep. 18, 2025

(54) APPARATUS AND METHOD FOR ACCESSIBLE RANKED-CHOICE VOTING

(71) Applicant: Clear Ballot Group, Inc., Boston, MA (US)

(72) Inventor: Ryuhi Segreto, Melrose, MA (US)

(21) Appl. No.: 18/607,087

(22) Filed: Mar. 15, 2024

(51) Int. Cl. G06F 3/0482

(52) U.S. Cl. CPC G06F 3/0482

(57) ABSTRACT

In an example ranked-choice voting method, data is stored that indicates the selection status and ranks of different options (e.g. candidates). While at least two options are selected, a user deselects one of the options. In response to deselection, the data is updated to indicate that the deselected option is in the unselected state, but the ranks of other options, including options with lower ranks, are not modified. Later, a user selects a new option, and the newly-selected option is given the highest rank that is not already associated with any other option. After selection is complete, an output is provided that indicates the ranks associated with the options, e.g. by printing a completed ballot.

### BACKGROUND

The present disclosure relates to systems and methods for use in ranked-choice voting. In particular, the disclosure relates to such systems and methods that can be configured for operation by voters using assistive input devices.

Ranked-choice voting (RCV), also referred to in various forms as ranked voting, instant runoff voting, or preferential voting, is a type of voting in which a voter is given the ability to select more than one option (e.g. more than one candidate or issue) in a single contest and to provide a ranking of each selected option. In general, vote tabulation for RCV contests is conducted in rounds until all contest positions are filled. The initial round of tabulation counts the first-ranked choice on each ballot. Based on the specific RCV type, candidates are then elected or eliminated, and surplus votes or ballots from eliminated candidates are added to the second ranked choices. In the next round, ballots for the remaining candidates are counted. Again, based on the RCV type, candidates may be elected or eliminated, and votes from elected or eliminated candidates are added to the next-ranked choice. The rounds continue, with votes from eliminated or elected higher-ranked choices distributed to the next-ranked candidate, until all seats are filled. With RCV, voters can prioritize multiple candidates, even in contests where only one winner is allowed.

Different ranked-choice voting systems may differ from one another in the specifics of how candidates are eliminated or elected in each round. In all such systems, however, it is desirable for every eligible voter to be able to enter their vote confidently, conveniently, independently, and privately regardless of any physical challenges those voters may have, and regardless of the voter's use of any assistive input devices or audio assistive devices. Nevertheless, ranked choice voting systems have not always been well adapted to voters with accessibility issues. As an example, Published U.S. Patent Application No. US20100019036A1, entitled “Electronic voting apparatus that is accessible to disabled voters,” describes a ranked-choice voting system in which each candidate is listed on the ballot “a number of times that is equal to the total number of candidates in that race,” with a different rank listed next to each instance of a candidate's name. For a race between only three candidates, this already requires nine separate entries on the ballot. But the ballot becomes even more unwieldy for a greater number of candidates. As described in that disclosure, “if there are 20 candidates in an instant runoff race, each candidate would be listed twenty times, with a First to Twentieth next to every candidates names [sic].” Such a ballot, however, would have four hundred entries for a single contest. The need to complete such a ballot with an assistive input device or an audio assistive device would be a formidable endeavor that would risk discouraging otherwise eligible voters from participating in an election.

### SUMMARY

A ranked-choice voting method according to some embodiments comprises: storing data that includes, for each of a plurality of options, an indication of whether the respective option is in a selected state or an unselected state, and for each of the options in the selected state, an indication of a respective assigned rank of the option from among a plurality of available ranks; while at least a first one of the options and a second one of the options are in a selected state, the first option having a higher rank (lower number) than the second option, receiving a user deselection input identifying the first option; in response to the user deselection input, updating the data to indicate that the first option is in the unselected state, wherein the ranks of options other than the first option are not modified in response to the deselection input; after updating the data in response to the user deselection input, receiving a user selection input identifying a third one of the options that is in the unselected state; in response to the user selection input, updating the data to indicate that the third option is in the selected state and to indicate that the rank of the third option is a highest rank (lowest number) not associated with any other option in the selected state; and providing an output indicating at least the ranks associated with the options in the selected state.

A ranked-choice voting apparatus according to some embodiments comprises one or more processors configured to perform at least: storing data that includes, for each of a plurality of options, an indication of whether the respective option is in a selected state or an unselected state, and for each of the options in the selected state, an indication of a respective assigned rank of the option from among a plurality of available ranks; while at least a first one of the options and a second one of the options are in a selected state, the first option having a higher rank than the second option, receiving a user deselection input identifying the first option; in response to the user deselection input, updating the data to indicate that the first option is in the unselected state, wherein the ranks of options other than the first option are not modified in response to the deselection input; after updating the data in response to the user deselection input, receiving a user selection input identifying a third one of the options that is in the unselected state; in response to the user selection input, updating the data to indicate that the third option is in the selected state and to indicate that the rank of the third option is a highest rank not associated with any other option in the selected state; and providing an output indicating at least the ranks associated with the options in the selected state.

In some embodiments, a non-transitory computer-readable medium stores instructions operative, when executed by one or more processors, to perform a method comprising: storing data that includes, for each of a plurality of options, an indication of whether the respective option is in a selected state or an unselected state, and for each of the options in the selected state, an indication of a respective assigned rank of the option from among a plurality of available ranks; while at least a first one of the options and a second one of the options are in a selected state, the first option having a higher rank than the second option, receiving a user deselection input identifying the first option; in response to the user deselection input, updating the data to indicate that the first option is in the unselected state, wherein the ranks of options other than the first option are not modified in response to the deselection input; after updating the data in response to the user deselection input, receiving a user selection input identifying a third one of the options that is in the unselected state; in response to the user selection input, updating the data to indicate that the third option is in the selected state and to indicate that the rank of the third option is a highest rank not associated with any other option in the selected state; and providing an output indicating at least the ranks associated with the options in the selected state.

Some embodiments further include, before receiving the user deselection input: receiving an initial plurality of user selection inputs, each of the initial plurality of user selection inputs identifying an initially-selected one of the options; and updating the data to assign a respective initial rank to each of the initially-selected options, the ranks corresponding to an order of the initial plurality of user selection inputs.

In some embodiments, the output is provided only in response to a user input indicating that selections are complete, and providing the output comprises causing the printing of a completed ballot or marking a preprinted ballot. In some such embodiments, in the output, at least an unassigned one of the available ranks is not assigned to any option, and at least one rank lower than the unassigned rank is assigned to an option.

Some embodiments further include providing a visual display including a name associated with each of the options, an indication of whether each displayed option is in the selected state, and an indication of the rank of those options in the selected state, wherein the visual display is updated in response to the user deselection input and the user selection input.

Some embodiments further include: in response to the user deselection input identifying the first option, providing an audio output including a name associated with the first option and indicating that the first option is in the unselected state; and in response to the user selection input identifying the third option, providing an audio output including a name associated with the third option and indicating a rank of the subsequent option.

Some embodiments further include: receiving user navigation input changing which option in a list of the options is in focus; wherein the user deselection input identifying the first option comprises receiving a first predetermined user input type while the deselected option is in focus; and wherein the user selection input identifying the third option comprises receiving a second predetermined user input type while the deselected option is in focus.

In some such embodiments, the first predetermined user input type is the same as the second predetermined user input type. In some such embodiments, the user deselection input identifying the first option and the user selection input identifying the third option are both a puff input. In some such embodiments, the user deselection input identifying the first option and the user selection input identifying the third option are both a sip input. Different input types (e.g. different accessible input types) may alternatively be used.

Some embodiments further include, in response to each user navigation input, providing an audio output indicating a name associated with the option currently in focus, and either an indication of a rank of the option currently in focus or an indication that the option currently in focus is in the unselected state.

### BRIEF DESCRIPTION OF THE DRAWINGS

FIG. 1 illustrates an example of a voter instruction screen in a ranked-choice voting system according to an embodiment.

FIGS. 2A-2B illustrate an example of an interface for ranked-choice voting according to an example embodiment.

FIG. 3 illustrates a portion of an interface for ranked-choice voting according to an example embodiment, showing user navigation to the option “Mount Rainier National Park (WA).”

FIG. 4 illustrates a portion of an interface for ranked-choice voting according to an example embodiment, showing a result of a user selection input identifying the option “Mount Rainier National Park (WA),” which is now shown as being in the selected state and having rank one.

FIG. 5 illustrates a portion of an interface for ranked-choice voting according to an example embodiment, showing a result of a plurality of user selections.

FIG. 6 illustrates a portion of an interface for ranked-choice voting according to an example embodiment, showing a result of a user deselection of the option “Olympic National Park (WA).”

FIG. 7 illustrates a portion of an interface for ranked-choice voting according to an example embodiment, showing a result of a user selection of the option “Yellowstone (ID, WY, MT).”

FIG. 8 illustrates a summary screen provided by an interface for ranked-choice voting according to an example embodiment.

FIG. 9 illustrates a confirmation warning provided by an interface for ranked-choice voting according to an example embodiment.

FIG. 10 illustrates a further summary screen provided by an interface for ranked-choice voting according to an example embodiment.

FIG. 11 illustrates an example output provided according to some embodiments. An output as shown in FIG. 11 may be printed on paper, e.g. for submission as a mail-in ballot.

FIG. 12 is a flow diagram illustrating a method performed according to some embodiments.

FIG. 13 is a functional block diagram illustrating components of an apparatus that may be used to implement some embodiments.

### DETAILED DESCRIPTION

In an example ranked-choice voting method, data is stored that indicates the selection status and ranks of different options (e.g. candidates). While at least two options are selected, a user deselects one of the options. In response to deselection, the data is updated to indicate that the deselected option is in the unselected state, but the ranks of other options, including options with lower ranks (higher numbers), are not modified by the deselection of the higher-ranked option. Later, a user selects a new option (which may be a re-selection of the previously deselected option), and the newly selected option is assigned to the highest rank that is not already associated with any other option. After selection is complete, an output is provided that indicates the ranks associated with the options, e.g. by printing a completed ballot.

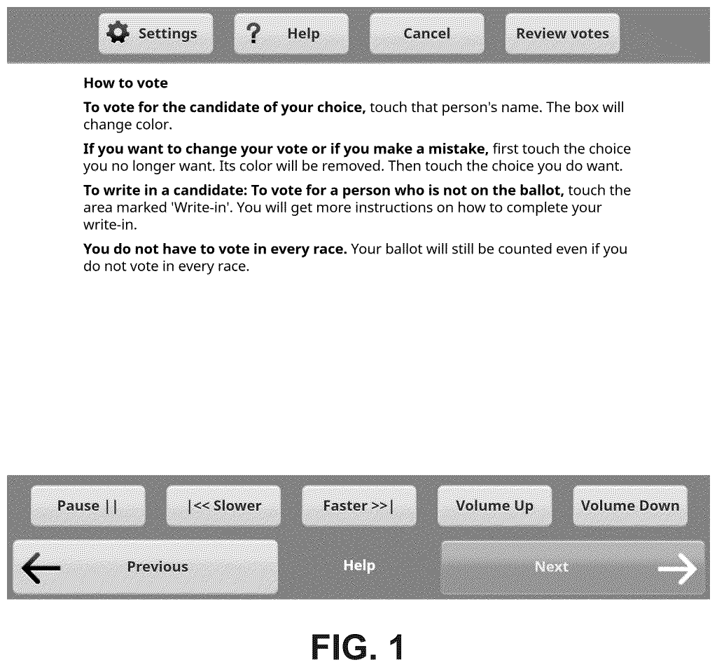

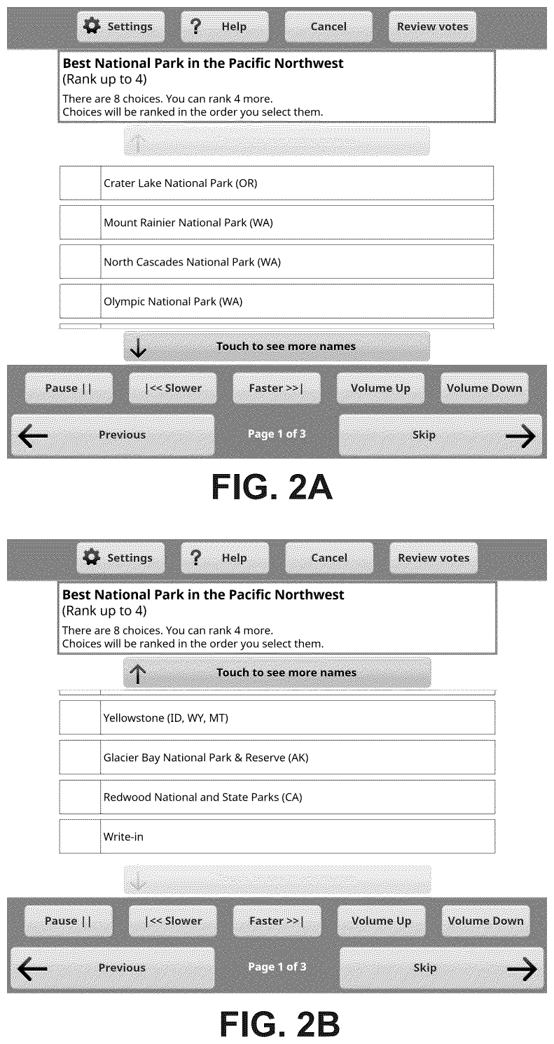

In an example of a ranked-choice voting apparatus and method, a voter may be presented with a voter instruction interface as shown in FIG. 1. The contents of the interface may be read to the voter through an audio assistive device. The voter may advance from the voter instruction interface to an interface as shown in FIGS. 2A-2B that allows for ranking of different options. FIG. 2B illustrates the result of scrolling down from the options visible in FIG. 2A to show all available options (seven named options, plus a “Write-in” option). Although the options illustrated in this example are different national parks in a hypothetical vote on the “Best National Park in the Pacific Northwest,” it should be understood that, depending on the relevant contest, the different options may be, for example, different candidates, different issues, or any other option capable of being the subject of an election.

The interface of FIGS. 2A-2B provides a visual display including a name associated with each of the options (such as the name “Crater Lake National Park (OR)”). The interface further includes an indication of whether each displayed option is in the selected state. At the stage shown in FIGS. 2A-2B, no options have yet been selected, so all options are shown in plain, un-highlighted text. Similarly, no ranks are shown for any of the options because no options have yet been selected.

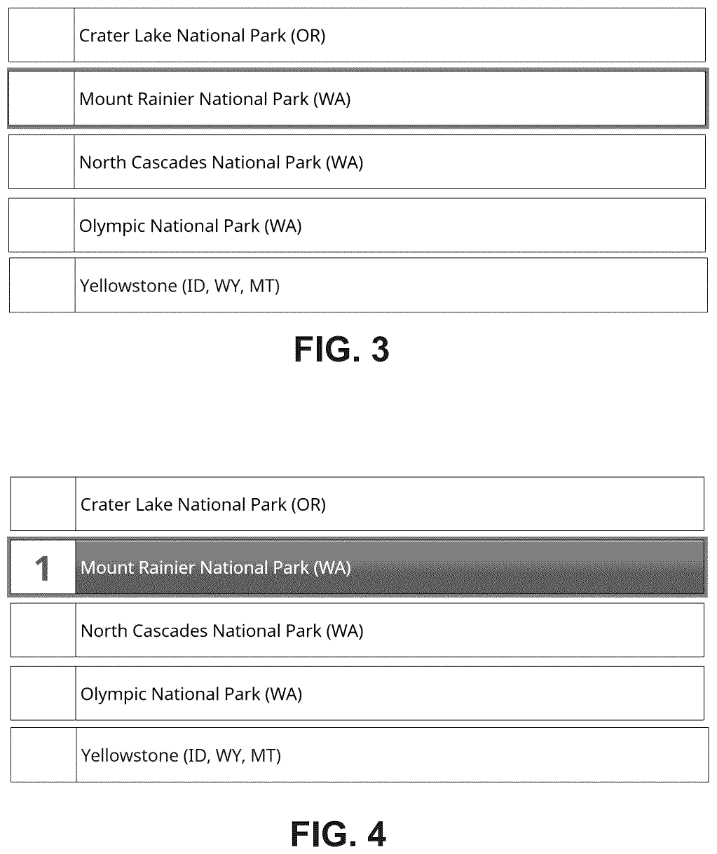

FIG. 3 illustrates a portion of the interface of FIGS. 2A-2B after the user has navigated to the option “Mount Rainier National Park.” For the sake of simplicity in FIG. 3 and subsequent illustrations, the upper controls “Settings,” “Help,” “Cancel,” and “Review votes” are not shown, and the lower controls “Pause,” “Slower,” “Faster,” “Volume Up,” “Volume Down,” “Previous,” and “Skip” are not shown, though it should be understood that these controls may still be displayed and available in some embodiments. Also, for simplicity, not all options are illustrated in FIG. 3.

As shown in FIG. 3, the option “Mount Rainier National Park” is in focus, as indicated by the thick frame around the name of that option. It should be understood that other techniques may be used to indicate which option is in focus. The system is responsive to voter input to change which option is in focus. Such input may be through arrow keys or buttons, computer mouse, trackball, touch screen, or sip-and-puff or other assistive technology. In some embodiments, an audio output may indicate which option is in focus and/or whether that option has yet been selected. For example, in response to navigating to “Mount Rainier National Park,” an audio output in this case may indicate “Mount Rainier National Park (WA) is not selected.”

While the option “Mount Rainier National Park” is in focus, the voter may provide a selection input indicating that Mount Rainier is selected. The selection input may take different forms but may be, for example, an input through keys or buttons, computer mouse, trackball, touch screen, or sip-and-puff or other assistive technology, among other options. The visual display provided by the interface may be updated in response to the selection. For example, as shown in FIG. 4, a screen area corresponding to Mount Rainier is filled in to indicate that this option has been selected. In addition, an indication of the rank associated with Mount Rainier is displayed via the number “1”. In some embodiments, the interface may further provide an audio output indicating the selection and the associated rank, such as “Mount Rainier National Park (WA) is selected and chosen for rank one.”

In some embodiments, the selection input is not necessarily different from the navigation input. For example, instead of navigating to an option and subsequently selecting the option in a separate action, the voter may click on the desired option or touch an active screen portion corresponding to the desired option, and the option may be selected without a separate navigation input.

Through further selection inputs (which may or may not include separate navigation inputs), the voter may thus provide an initial plurality of user selection inputs, with each of the initial plurality of user selection inputs identifying an initially selected one of the options. The system may store data that includes, for each of the options, an indication of whether the respective option is in a selected state or an unselected state. For each of the options in the selected state, the system may further store an indication of a respective assigned rank of the option from among a plurality of available ranks. The information regarding the state of the option may or may not be stored separately from the information regarding the rank. For example, a variable for each option may store a value indicating the rank of the option if that option has a rank, and the same variable may store a zero (or a null value or some other value that cannot be confused with a rank) for unselected options. In another embodiment, a separate flag may be used for each option to indicate whether that option is in the selected state. Various different techniques are contemplated for storing the relevant data.

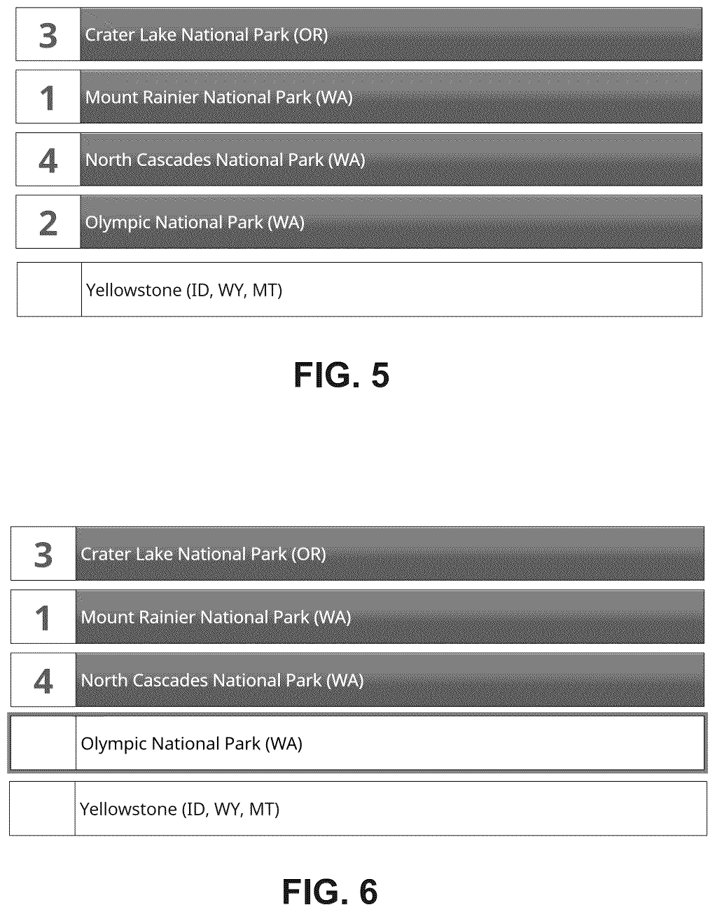

In response to the selection of an option, the data is updated to indicate the appropriate option is in a selected state and to indicate the rank of the option. In an example embodiment, the initial ranks assigned to each option are assigned to correspond to the order of the initial plurality of user selection inputs. For example, if, after initial selection of Mount Rainier National Park (WA), the subsequent selections, in order, are selections of Olympic National Park (WA), Crater Lake National Park (OR), and North Cascades National Park (WA), the interface will be updated as shown in FIG. 5 to reflect the updated data, in which those options have been selected, and they are assigned ranks that correspond to their selection order.

In the example of FIG. 5, a visual indication is provided of the rank of those options in the selected state. In addition, an audio indication of the rank of the options of the selected state may also be provided. For example, in response to user navigation to Crater Lake, an audio indication may be provided, such as “Crater Lake National Park (OR) is selected and chosen for rank three.”

Example embodiments further allow voters to deselect options that they have previously selected. For example, the voter may provide a navigation input to navigate to the option the user wishes to deselect, and the voter may provide an input indicating that the option in focus should be deselected. As with other inputs described herein, the deselection input may be provided, for example, through keys or buttons, computer mouse, trackball, touch screen, or sip-and-puff or other assistive technology. As further described above with regard to selection inputs, no separate navigation input is necessarily required (e.g. the voter may deselect an option by clicking or touching a screen area corresponding to the option being deselected).

In some embodiments, the selection input and the deselection input may be the same type of input. For example, a click on an area corresponding to an option may be treated as a selection input if the option is currently in the unselected state, and it may be treated as a deselection input if the option is currently in the selected state. Similarly, a predetermined input type from an assistive technology device (e.g. a short puff input from a sip and puff assistive input device) may be treated as a selection input if the option currently in focus is in the unselected state, and it may be treated as a deselection input if the option currently in focus is in the selected state. Such embodiments limit the number of different types of inputs that need to be provided to allow for successful voting. Moreover, such embodiments limit the amount of navigation that may be required for successful voting. For example, voters using such embodiments do not necessarily need to navigate to a separate “deselect” button to deselect an option that was selected in error. The limited number of different types of inputs that are needed, and the reduced amount of navigation required, are of particular value for users who are voting with the use of assistive technology.

FIG. 6 illustrates an example of the interface of FIG. 5 as updated in response to a user input deselecting Olympic National Park. In response to the deselection input, the data is updated to reflect that Olympic National Park is in the unselected state and no longer has an assigned rank. The interface as shown in FIG. 6 provides a visual display of the relevant data resulting from the deselection. In addition, an audio output may be provided in response to the deselection input, such as “Olympic National Park (WA) is not selected.”

In this example, the deselected option had a rank of two, and two other options had lower ranks. Specifically, Crater Lake had rank three, and North Cascades had rank four. However, in this embodiment, the ranks of options that were not deselected are not modified in response to the deselection input, even though they may have ranks lower than the rank of the deselected option. For example, the ranks of Crater Lake and North Cascades remain three and four, respectively, even though there is no longer an option with rank two.

Embodiments that do not re-rank options when a more highly ranked option is deselected help to improve the accessibility of the ranked-choice voting system. For example, a voter relying on audio presentation of the ballot selections can trust that choices are not being automatically re-ranked without an audible confirmation. (An audible description of re-rankings could in theory be provided, but it would be potentially lengthy and confusing, considering that the de-selection of a single option could cause the re-ranking of a large number of other options.) In addition, a voter with difficulty operating the input devices may accidentally de-select an option, and the absence of automatic re-ranking allows the voter to re-select the same option to return to the desired ranking.

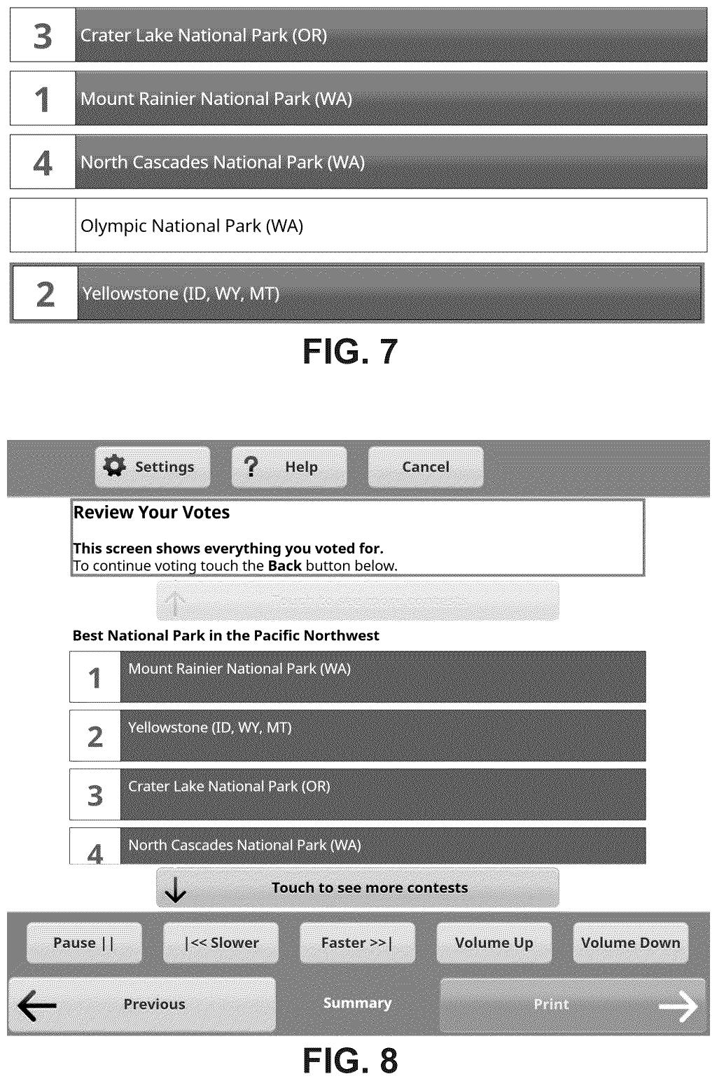

In the example as shown in FIG. 7, the user has provided a further user selection input identifying one of the options that was in the unselected state, namely Yellowstone. In this embodiment, the data is updated to indicate that Yellowstone is in the selected state and to assign to Yellowstone the highest rank that is not currently associated with any other option in the selected state. In this case, the highest rank not associated with any other option is rank two (previously assigned to Olympic National Park).

Once a voter has entered their desired rankings, the system may provide the voter with a display of the selected options rearranged into rank order, as shown for example in FIG. 8, for final review. Once the voter is satisfied that their vote has been entered correctly, the voter may provide an input indicating that selections are complete. Such an input may be made, for example, by clicking or otherwise selecting the “Print” button illustrated in FIG. 8. The system then provides an output indicating at least the ranks associated with those options that are in the selected state.

The output may be provided in various ways. For example, in some embodiments, the output may be provided by printing a completed ballot. Such embodiments may be used, for example, by users casting their ballots on a home computer and printing them for use as mail-in ballots. In some embodiments, the output may be provided by marking (using a printer or analogous device) the appropriate selections on a pre-printed ballot. In some embodiments, the output may be made in the form of a secure transmission or storage of the ranks assigned by the voter.

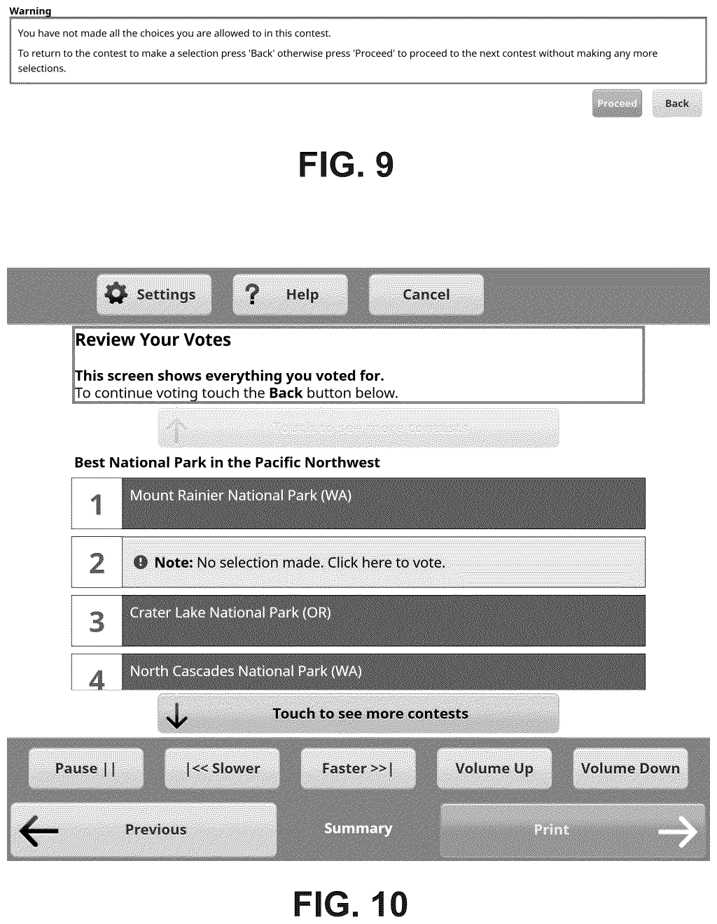

In the example provided above, the voter assigned all of the assignable ranks (one through four in this example) to various options. In some embodiments, the voter is permitted to cast a ballot without assigning all available ranks. For example, after de-selecting Olympic National Park, (as shown in FIG. 6), the voter may decide not to assign the rank “two” to any option. FIG. 9 illustrates an example of an alert that may be provided to a user who attempts to proceed without assigning all ranks. If the voter still wishes to proceed, the interface may provide a summary as shown in FIG. 10 (analogous to FIG. 8), indicating that the rank “two” has not been assigned to any option. The voter may be given the final option of continuing to cast their ballot without assigning all ranks. In example embodiments, the output may be provided (after sufficient confirmation is received from the voter) even though at least one of the available ranks is not assigned to any option. This may be the case even if there is a “skipped” rank, e.g. where at least one rank lower than the unassigned rank is assigned to an option.

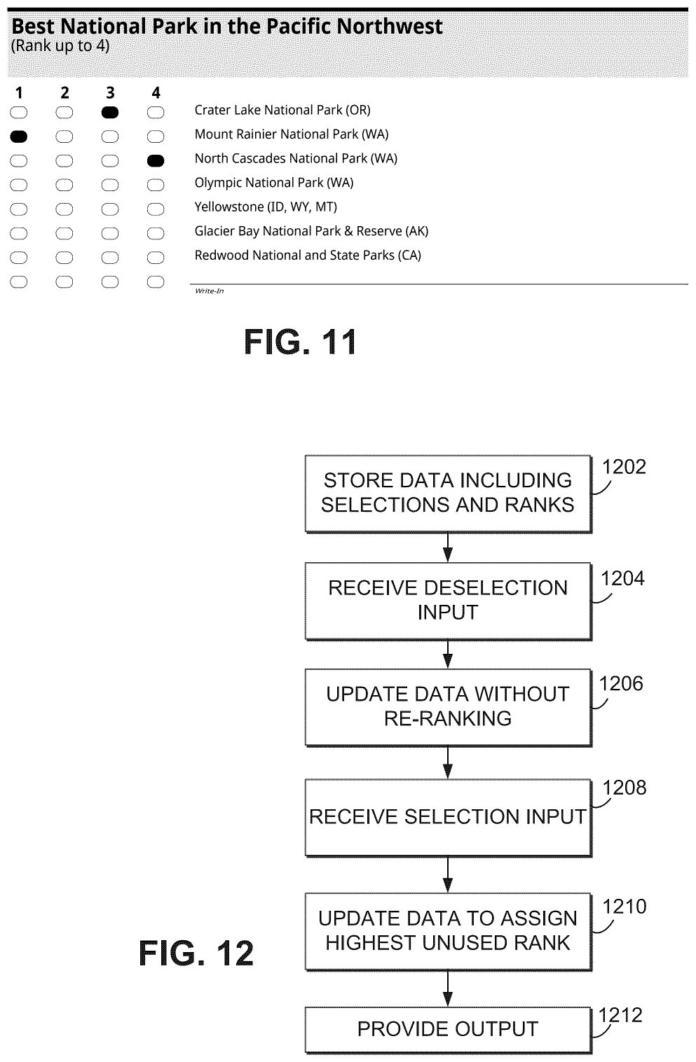

An example of an output according to some embodiments is illustrated in FIG. 11. FIG. 11 may represent a region of a ballot printed with the results as selected in the interface of FIG. 10. In some embodiments, votes from a plurality of different contests may be printed on the same ballot. In addition, example embodiments allow for votes in different types of contests (e.g. contests in which the voter can select no more than one option) to be printed on the same ballot.

In some embodiments, a ranked-choice voting method as described herein may be offered through a secure web interface, allowing voters to vote, e.g. on their own computer, on a work computer, on a smartphone, on a school or public library computer, or the like. For example, after a voter has provided appropriate credentials, they may be permitted to enter their selections through a web interface implemented by HTML, JavaScript, and/or other web interface technology, with the possible use of assistive input devices. An output may be provided, for example, through a printer that is networked to or connected directly to the computer. For example, the output may be provided as a printed ballot that can be submitted by the voter as a mail-in ballot. Example embodiments are not limited to any specific form of output. For example, output may be provided in electronic form (e.g. over the internet) in scenarios where sufficient public trust has been established in the security of electronic voting, or in scenarios where the outcome has comparatively low stakes (e.g. voting for a condominium board, or for favorite travel destinations).

Some embodiments are implemented entirely or in part with the use of ballot marking device (BMD) hardware. A ballot marking device that may be used in some embodiments may include a touchscreen and/or other input devices (including assistive input devices), printer, scanner, headphones, elections medium storage, battery, power supply, and/or other components.

In some embodiments, the ballot marking device is configured to perform ballot verification. In an example ballot verification process, the completed ballot (which may be a ballot printed or otherwise marked according to embodiments described herein) is scanned, and visual and/or audio representation of the voter's selections are conveyed to the voter, together with any applicable voter warnings (e.g. skipped ranks, blank votes, overvotes, etc.). A ballot verification display (and/or corresponding audio presentation) used in a ballot verification process may be similar to the display of the Summary screens as shown in FIG. 8 and FIG. 10. In some embodiments, the ballot verification process is configured to provide additional warnings (as applicable) that may not have been available before the ballot was marked. For example, the ballot verification process may be configured to provide a warning in case of an overvote (too many selections in a particular contest). The software interface of the ballot marking device may be configured to prevent the user from entering an overvote, but the ballot verification process provides an extra layer of confirmation that the voter's selections were correctly recorded on the paper ballot and correctly interpreted by the tabulator. In example embodiments, the ballot verification displays (or otherwise presents) the voter's selections by tabulating the scanned paper ballot image, without reliance on any electronic record of the voter's selections.

A method performed in some embodiments is illustrated by the flow chart of FIG. 12. At 1202, data is stored that includes, for each of a plurality of options, an indication of whether the respective option is in a selected state or an unselected state, and for each of the options in the selected state, an indication of a respective assigned rank of the option from among a plurality of available ranks.

At 1204, while at least a first one of the options and a second one of the options are in a selected state, a user deselection input is received that identifies the first option. It should be noted here that references to a “first option,” “second option,” and the like are meant only to clarify which option is being referred to; the modifiers “first” and “second” do not necessarily bear any relation to the ranks assigned to those options or to the order in which those options may have been selected by a user. In some cases, the “first option” may be the same specific option as the “second” or “third” option unless stated otherwise. For example, a user may deselect a “first option” and then select a “third option” by deselecting Olympic National Park and then re-selecting that same park.

At 1206, in response to the user deselection input, the data is updated to indicate that the first option is in the unselected state. In this embodiment, the ranks of options other than the first option are not modified in response to the deselection input. For example, even if there is a second option with a rank lower than the rank of the deselected first option, the rank of the second option is not incremented or otherwise updated in response to the deselection input. (Nevertheless, the user may provide later inputs that do affect the rank of the second option, e.g. by de-selecting the second option, filling its place with a third option, and then re-selecting the second option.)

At 1208, after updating the data in response to the user deselection input, a user selection input is received identifying a third one of the options that is in the unselected state. (This may be a re-selection of the deselected first option, which itself may now be in the unselected state.)

At 1210, in response to the user selection input, the data is updated to indicate that the third option is in the selected state and to indicate that the rank of the third option is a highest rank not associated with any other option in the selected state.

At 1212, an output is provided indicating at least the ranks associated with the options in the selected state.

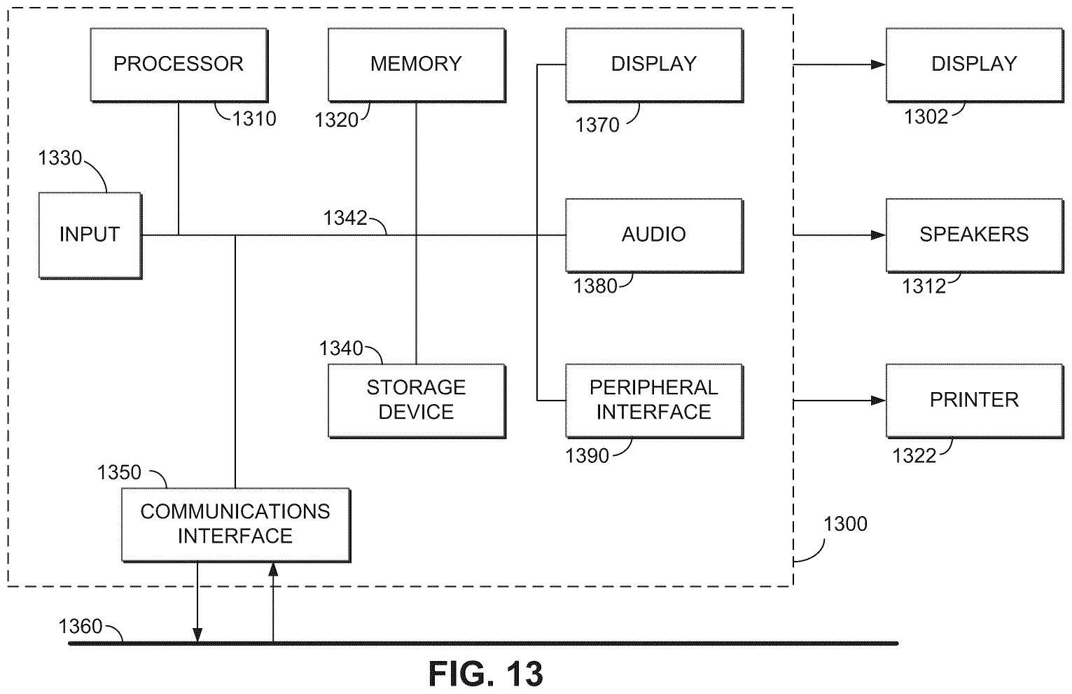

Example embodiments of an apparatus (which may include a personal or shared computer and/or a specialized voting system) configured to implement embodiments described herein may be implemented using systems such as the system of FIG. 13. System 1300 can be embodied as a device including the various components described below and is configured to perform one or more of the aspects described in this document. Examples of such devices include, but are not limited to, various electronic devices such as personal computers, laptop computers, smartphones, tablet computers, digital multimedia set top boxes, digital television receivers, personal video recording systems, connected home appliances, and servers. Elements of system 1300, singly or in combination, can be embodied in a single integrated circuit (IC), multiple ICs, and/or discrete components. For example, in at least one embodiment, the processing elements of system 1300 are distributed across multiple ICs and/or discrete components. In various embodiments, the system 1300 is communicatively coupled to one or more other systems, or other electronic devices, via, for example, a communications bus or through dedicated input and/or output ports. In various embodiments, the system 1300 is configured to implement one or more of the aspects described in this document.

The system 1300 includes at least one processor 1310 configured to execute instructions loaded therein for implementing, for example, the various aspects described in this document. Processor 1310 can include embedded memory, input output interface, and various other circuitries as known in the art. The system 1300 includes at least one memory 1320 (e.g., a volatile memory device, and/or a non-volatile memory device). System 1300 includes a storage device 1340, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 1340 can include an internal storage device, an attached storage device (including detachable and non-detachable storage devices), and/or a network accessible storage device, as non-limiting examples.

Program code to be loaded onto processor 1310 to perform the various aspects described in this document can be stored in storage device 1340 and subsequently loaded onto memory 1320 for execution by processor 1310. In accordance with various embodiments, one or more of processor 1310, memory 1320, and storage device 1340 can store one or more of various items during the performance of the processes described in this document. Such stored items can include, but are not limited to, data regarding the various voting options, data indicating whether those options are in a selected or unselected state, and data indicating a rank of the selected options.

In some embodiments, memory inside of the processor 1310 is used to store instructions and to provide working memory for processing. In other embodiments, however, a memory external to the processing device is used for one or more of these functions. The external memory can be the memory 1320 and/or the storage device 1340, for example, a dynamic volatile memory and/or a non-volatile flash memory.

The input to the elements of system 1300 can be provided through various input devices as indicated in block 1330. Such input devices include, but are not limited to, a Universal Serial Bus (USB) input terminal, or a radio frequency (RF) portion that receives a secure RF signal transmitted, for example, over a wireless network. In various embodiments, the input devices of block 1330 have associated respective input processing elements as known in the art.

Various elements of system 1300 can be provided within an integrated housing, Within the integrated housing, the various elements can be interconnected and transmit data therebetween using suitable connection arrangement 1342, for example, an internal bus as known in the art, wiring, and printed circuit boards.

The system 1300 may include a communication interface 1350 that enables communication with other devices via communication channel 1360. The communication interface 1350 can include, but is not limited to, a transceiver configured to transmit and to receive data over communication channel 1360. The communication interface 1350 can include, but is not limited to, a modem or network card and the communication channel 1360 can be implemented, for example, within a wired and/or a wireless medium.

The system 1300 can provide an output signal to various output devices, including a display 1302, speakers 1312, printer 1322, and other peripheral devices. The display 1302 of various embodiments includes one or more of, for example, a touchscreen display, an organic light-emitting diode (OLED) display, a curved display, and/or a foldable display. The display 1302 can be implemented using a monitor, a tablet, a laptop, a smartphone, or other device. The display 1302 can also be integrated with other components (for example, as in a smartphone), or separate (for example, an external monitor for a laptop). Other peripheral devices may include, in various examples of embodiments, assistive input devices including but not limited to sip-and-puff input devices.

In various embodiments, control signals are communicated between the system 1300 and the display 1302, speakers 1312, printer 1322, or other peripheral devices using any signaling or communications protocol that enables device-to-device control with or without user intervention. The output devices can be communicatively coupled to system 1300 via dedicated connections through respective interfaces 1370, 1380, and 1390. Alternatively, the output devices can be connected to system 1300 using the communications channel 1360 via the communications interface 1350. One or more of the display 1302, speakers 1312, and printer 1322 can be integrated in a single unit with the other components of system 1300. The display 1302, speakers 1312, and printer 1322 can alternatively be separate from one or more of the other components.

The embodiments can be carried out by computer software implemented by the processor 1310 or by hardware, or by a combination of hardware and software. As a non-limiting example, the embodiments can be implemented by one or more integrated circuits. The memory 1320 can be of any type appropriate to the technical environment and can be implemented using any appropriate data storage technology, such as optical memory devices, magnetic memory devices, semiconductor-based memory devices, fixed memory, and removable memory, as non-limiting examples. The processor 1310 can be of any type appropriate to the technical environment, and can encompass one or more of microprocessors, general purpose computers, special purpose computers, and processors based on a multi-core architecture, as non-limiting examples.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first selection” and a “second selection”. Use of such terms does not imply an ordering to the modified operations unless specifically required. So, in this example, the first selection need not be performed before the second selection, and may occur, for example, before, during, or in an overlapping time period with the second selection.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Various hardware elements of one or more of the described embodiments may be implemented as modules that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as media commonly referred to as RAM, ROM, etc.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Other variations of the described embodiments are contemplated. The above-described embodiments are intended to be illustrative, rather than restrictive, of the present invention. The scope of the invention is thus not limited by the examples given above but rather is defined by the following claims.

1. A ranked-choice voting method comprising:
storing data that includes, for each of a plurality of options, an indication of whether the respective option is in a selected state or an unselected state, and for each of the options in the selected state, an indication of a respective assigned rank of the option from among a plurality of available ranks;
while at least a first one of the options and a second one of the options are in a selected state, the first option having a higher rank than the second option, receiving a user deselection input identifying the first option;
in response to the user deselection input, updating the data to indicate that the first option is in the unselected state, wherein the ranks of options other than the first option are not modified in response to the deselection input;
after updating the data in response to the user deselection input, receiving a user selection input identifying a third one of the options that is in the unselected state;
in response to the user selection input, updating the data to indicate that the third option is in the selected state and to indicate that the rank of the third option is a highest rank not associated with any other option in the selected state; and
providing an output indicating at least the ranks associated with the options in the selected state.

2. The method of claim 1, further comprising, before receiving the user deselection input:
receiving an initial plurality of user selection inputs, each of the initial plurality of user selection inputs identifying an initially-selected one of the options; and
updating the data to assign a respective initial rank to each of the initially-selected options, the ranks corresponding to an order of the initial plurality of user selection inputs.

3. The method of claim 1, wherein the output is provided only in response to a user input indicating that selections are complete, and wherein providing the output comprises causing the printing of a completed ballot or marking a preprinted ballot.

4. The method of claim 3, wherein, in the output, at least an unassigned one of the available ranks is not assigned to any option, and at least one rank lower than the unassigned rank is assigned to an option.

5. The method of claim 1, further comprising providing a visual display including a name associated with each of the options, an indication of whether each displayed option is in the selected state, and an indication of the rank of those options in the selected state, wherein the visual display is updated in response to the user deselection input and the user selection input.

6. The method of claim 1, further comprising:
in response to the user deselection input identifying the first option, providing an audio output including a name associated with the first option and indicating that the first option is in the unselected state; and
in response to the user selection input identifying the third option, providing an audio output including a name associated with the third option and indicating a rank of the subsequent option.

7. The method of claim 1, further comprising:
receiving user navigation input changing which option in a list of the options is in focus;
wherein the user deselection input identifying the first option comprises receiving a first predetermined user input type while the deselected option is in focus; and
wherein the user selection input identifying the third option comprises receiving a second predetermined user input type while the deselected option is in focus.

8. The method of claim 7, further comprising, in response to each user navigation input, providing an audio output indicating a name associated with the option currently in focus, and either an indication of a rank of the option currently in focus or an indication that the option currently in focus is in the unselected state.

9. The method of claim 7, wherein the first predetermined user input type is the same as the second predetermined user input type.

10. The method of claim 1, wherein the user deselection input identifying the first option and the user selection input identifying the third option are both a puff input or are both a sip input.

11. A ranked-choice voting apparatus comprising one or more processors configured to perform at least:
storing data that includes, for each of a plurality of options, an indication of whether the respective option is in a selected state or an unselected state, and for each of the options in the selected state, an indication of a respective assigned rank of the option from among a plurality of available ranks;
while at least a first one of the options and a second one of the options are in a selected state, the first option having a higher rank than the second option, receiving a user deselection input identifying the first option;
in response to the user deselection input, updating the data to indicate that the first option is in the unselected state, wherein the ranks of options other than the first option are not modified in response to the deselection input;
after updating the data in response to the user deselection input, receiving a user selection input identifying a third one of the options that is in the unselected state;
in response to the user selection input, updating the data to indicate that the third option is in the selected state and to indicate that the rank of the third option is a highest rank not associated with any other option in the selected state; and
providing an output indicating at least the ranks associated with the options in the selected state.

12. The apparatus of claim 11, further configured to perform, before receiving the user deselection input:
receiving an initial plurality of user selection inputs, each of the initial plurality of user selection inputs identifying an initially-selected one of the options; and
updating the data to assign a respective initial rank to each of the initially-selected options, the ranks corresponding to an order of the initial plurality of user selection inputs.

13. The apparatus of claim 11, wherein the output is provided only in response to a user input indicating that selections are complete, and wherein providing the output comprises causing the printing of a completed ballot or marking a preprinted ballot.

14. The apparatus of claim 13, wherein, in the output, at least an unassigned one of the available ranks is not assigned to any option, and at least one rank lower than the unassigned rank is assigned to an option.

15. The apparatus of claim 11, further configured to provide a visual display including a name associated with each of the options, an indication of whether each displayed option is in the selected state, and an indication of the rank of those options in the selected state, wherein the visual display is updated in response to the user deselection input and the user selection input.

16. The apparatus of claim 11, further configured to perform:
in response to the user deselection input identifying the first option, providing an audio output including a name associated with the first option and indicating that the first option is in the unselected state; and
in response to the user selection input identifying the third option, providing an audio output including a name associated with the third option and indicating a rank of the subsequent option.

17. The apparatus of claim 11, further configured to perform:
receiving user navigation input changing which option in a list of the options is in focus;
wherein the user deselection input identifying the first option comprises receiving a first predetermined user input type while the deselected option is in focus; and
wherein the user selection input identifying the third option comprises receiving a second predetermined user input type while the deselected option is in focus, the second predetermined user input type being the same as the first predetermined user input type.

18. The apparatus of claim 17, further configured to perform, in response to each user navigation input, providing an audio output indicating a name associated with the option currently in focus, and either an indication of a rank of the option currently in focus or an indication that the option currently in focus is in the unselected state.

19. The apparatus of claim 11, wherein the user deselection input identifying the first option and the user selection input identifying the third option are both a puff input or are both a sip input.

20. A non-transitory computer-readable medium storing instructions operative, when executed by one or more processors, to perform a method comprising:
storing data that includes, for each of a plurality of options, an indication of whether the respective option is in a selected state or an unselected state, and for each of the options in the selected state, an indication of a respective assigned rank of the option from among a plurality of available ranks;
while at least a first one of the options and a second one of the options are in a selected state, the first option having a higher rank than the second option, receiving a user deselection input identifying the first option;
in response to the user deselection input, updating the data to indicate that the first option is in the unselected state, wherein the ranks of options other than the first option are not modified in response to the deselection input;
after updating the data in response to the user deselection input, receiving a user selection input identifying a third one of the options that is in the unselected state;
in response to the user selection input, updating the data to indicate that the third option is in the selected state and to indicate that the rank of the third option is a highest rank not associated with any other option in the selected state; and
providing an output indicating at least the ranks associated with the options in the selected state.
